(19) United States
(12) Patent Application Publication
(10) Pub. No.: US 2024/0231146 A1
(43) Pub. Date: Jul. 11, 2024

(54) LIGHT FLUX CONTROLLING MEMBER, LIGHT EMITTING DEVICE, SURFACE LIGHT SOURCE DEVICE AND DISPLAY DEVICE

(71) Applicant: Enplas Corporation, Saitama (JP)

(72) Inventor: Takuro MOMOI, Saitama (JP)

(21) Appl. No.: 17/906,402

(22) PCT Filed: Mar. 19, 2021
(86) PCT No.: PCT/JP2021/011438

§ 371 Date: Mar. 20, 2023

(30) Foreign Application Priority Data
Mar. 19, 2020 (JP) 2020-049741
Jun. 30, 2020 (JP) 2020-113517
Nov. 20, 2020 (JP) 2020-193511

(51) Int. Cl. G02F 1/13357

(52) U.S. Cl. CPC G02F 1/133605; G02F 1/133603; G02F 1/133606

(57) ABSTRACT

This light flux control member comprises: a plurality of incidence units on which light emitted from a plurality of light emitting elements is incident, and an emission unit which is disposed between the plurality of incidence units, and guides and emits therefrom the light incident on the plurality of incidence units. The plurality of incidence units each have an incidence surface, and a first reflection surface which reflects light incident on the incidence surface in a direction along a substrate. The emission unit has a second emission surface which is disposed to face the substrate and reflects light from the incidence unit, a first emission surface which is disposed to face the second emission surface and from which the light from the incidence unit is emitted, and an emission promotion part for promoting emission of light.

### TECHNICAL FIELD

The present invention relates to a light flux controlling member configured to control the distribution of light emitted from a light emitting element, a light emitting device including the light flux controlling member, a surface light source device including the light emitting device, and a display device including the surface light source device.

### BACKGROUND ART

In recent years, a direct surface light source device including a plurality of light emitting elements as a light source is used in transmission image display devices such as liquid crystal displays. A large number of light emitting elements may be disposed to allow light to illuminate a wide range.

Patent Literature (hereinafter, referred to as PTL) 1 discloses a light flux controlling member (microarray lens) suitable for being disposed over a large number of light emitting elements. A large number of lenses are connected by a support plate in these microarray lenses, and one microarray lens is disposed above the large number of light emitting elements (mini LEDs) disposed on a substrate. This configuration eliminates the necessity to dispose lenses individually above corresponding light emitting elements, thereby improving the handling property at the time of mounting and facilitating the mounting.

### CITATION LIST

### Patent Literature

PTL 1
Chinese Patent Application Publication No. 110208984

### SUMMARY OF INVENTION

### Technical Problem

Although the above-described light flux controlling member (microarray lens) has a suitable handling property at the time of mounting, the light flux controlling member may become thick for distributing the light from the light emitting elements as desired. As a result, a surface light source device with such a light flux controlling member may also become thick.

The present invention has been made in view of the above circumstances. An object of the present invention is to provide a light flux controlling member capable of appropriately distributing light from the plurality of light emitting elements while the handling property at the time of mounting is improved by disposing the light flux controlling member above a plurality of light emitting elements.

Another object of the present invention is to provide a light emitting device, a surface light source device, and a display device which include the light flux controlling member.

### Solution to Problem

A light flux controlling member of the present invention is for controlling a distribution of light emitted from a plurality of light emitting elements disposed on or above a substrate, the light flux controlling member comprising:
a plurality of incidence units for allowing incidence of the light emitted from the plurality of light emitting elements, respectively; and an emission unit disposed between the plurality of incidence units in a direction along the substrate, the emission unit emitting the light incident on the plurality of incidence units while guiding the light,
in which each of the plurality of incidence units includes: an incidence surface disposed on a back side of the light flux controlling member, the incidence surface allowing incidence of the light emitted from the light emitting element, and a first reflection surface disposed at a position opposite to each of the plurality of light-emitting elements with the incidence surface provided between the reflection surface and each of the plurality of light-emitting elements on a front side of the light flux controlling member, the reflection surface being configured to laterally reflect light entered from the incidence surface in a direction away from an optical axis of each of the plurality of light-emitting elements, and
in which the emission unit includes: a second emission surface disposed on the back side of the light flux controlling member, the second emission surface reflecting a part of the light from the plurality of incidence units and emitting another part of the light, a first emission surface disposed on the front side of the light flux controlling member so as to face the second emission surface, the first emission surface reflecting a part of the light from the plurality of incidence units and emitting another part of the light, and an emission promotion part disposed in at least one of the second emission surface and the first emission surface, the emission promotion part being for promoting emission of light traveling between the second emission surface and the first emission surface.

A light emitting device of the present invention includes a plurality of light emitting elements disposed on or above a substrate; and the above-described light flux controlling member disposed on or above the plurality of light emitting elements.

A surface light source device of the present invention includes a plurality of above-described light emitting devices and a light diffusion plate that transmits light emitted from the plurality of light emitting devices while diffusing the light.

A display device of the present invention includes the above-described surface light source device and a display member to be illuminated by light emitted from the surface light source device.

### Advantageous Effects of Invention

The present invention can provide a light flux controlling member capable of appropriately distributing light from the plurality of light emitting elements while the handling property at the time of mounting is improved by disposing the light flux controlling member above a plurality of light emitting elements.

The present invention can also provide a light emitting device, a surface light source device, and a display device which include the light flux controlling member.

### BRIEF DESCRIPTION OF DRAWINGS

FIGS. 1A and 1B illustrate the configuration of a surface light source device according to Embodiment 1;

FIGS. 2A to 2C illustrate the configuration of the surface light source device according to Embodiment 1;

FIG. 3 is a partially enlarged view of FIG. 2B;

FIGS. 4A to 4C illustrate the configuration of a light flux controlling member according to Embodiment 1;

FIGS. 5A to 5D are cross-sectional views of the light flux controlling member according to Embodiment 1;

FIGS. 6A and 6B illustrate a modification of an emission promotion part;

FIGS. 7A and 7B illustrate a modification of the emission promotion part;

FIGS. 8A and 8B illustrate a modification of the emission promotion part;

FIGS. 9A and 9B illustrate a modification of the emission promotion part;

FIGS. 10A and 10B illustrate optical paths in a light emitting device according to Embodiment 1;

FIGS. 11A to 11C illustrate the illuminance distribution in the light emitting device according to Embodiment 1;

FIGS. 12A and 12B illustrate the illuminance distribution in the light emitting device according to Embodiment 1;

FIGS. 13A to 13C illustrate a modification of the light flux controlling member according to Embodiment 1;

FIGS. 14A to 14C illustrate a modification of the light flux controlling member according to Embodiment 1;

FIGS. 15A to 15D illustrate the configuration of a light flux controlling member according to Embodiment 2;

FIGS. 16A to 16C are cross-sectional views of the light flux controlling member according to Embodiment 2;

FIGS. 17A to 17C illustrate the illuminance distribution in the light emitting device according to Embodiment 2 and in another light emitting device;

FIGS. 18A to 18E illustrate the configuration of a light flux controlling member according to a modification;

FIG. 19 illustrates a state in which a reflective sheet is pressed by a third reflection surface of the light flux controlling member;

FIGS. 20A and 20B illustrate the illuminance distribution in a light emitting device according to a modification;

FIGS. 21A to 21E illustrate the configuration of a light flux controlling member according to a modification;

FIGS. 22A and 22B illustrate the illuminance distribution in a light emitting device according to a modification;

FIGS. 23A and 23B illustrate the configuration of a light flux controlling member according to a modification;

FIGS. 24A and 24B illustrate the illuminance distribution in a light emitting device according to a modification;

FIGS. 25A and 25B are enlarged views of a light beam direction changing part;

FIG. 26 is an enlarged cross-sectional view illustrating a fourth emission surface and a re-incidence surface;

FIG. 27A illustrates the configuration of a modification of an incidence surface, and FIG. 27B illustrates the configuration of a modification of a first reflection surface;

FIG. 28A illustrates the configuration of a modification of the incidence surface, and FIG. 28B illustrates the configuration of a modification of the first reflection surface;

FIG. 29A illustrates the configuration of a modification of the incidence surface, and FIG. 29B illustrates the configuration of a modification of the first reflection surface;

FIG. 30A illustrates the configuration of a modification of the incidence surface, and FIG. 30B illustrates the configuration of a modification of the first reflection surface;

FIGS. 31A and 31B illustrate the configurations of modifications of the incidence surface; and

FIG. 32 is a diagram for explaining how to mount the light flux controlling member.

### DESCRIPTION OF EMBODIMENTS

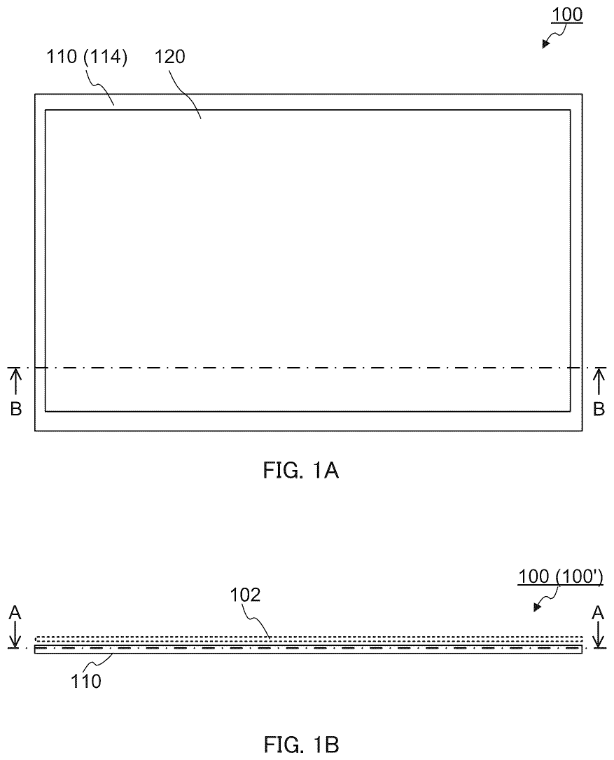

Hereinafter, one or more embodiments of the present invention will be described in detail with reference to the drawings. In the following description, a surface light source device suitable for a backlight of a liquid crystal display device or the like will be described as a typical example of the surface light source device according to the present invention. Such a surface light source device can be used as display device 100′ in combination with display member 102 (for example, a liquid crystal panel) which is to be illuminated by light from the surface light source device (see FIG. 1B).

### Embodiment 1

### Configurations of Surface Light Source Device and Light Emitting Device

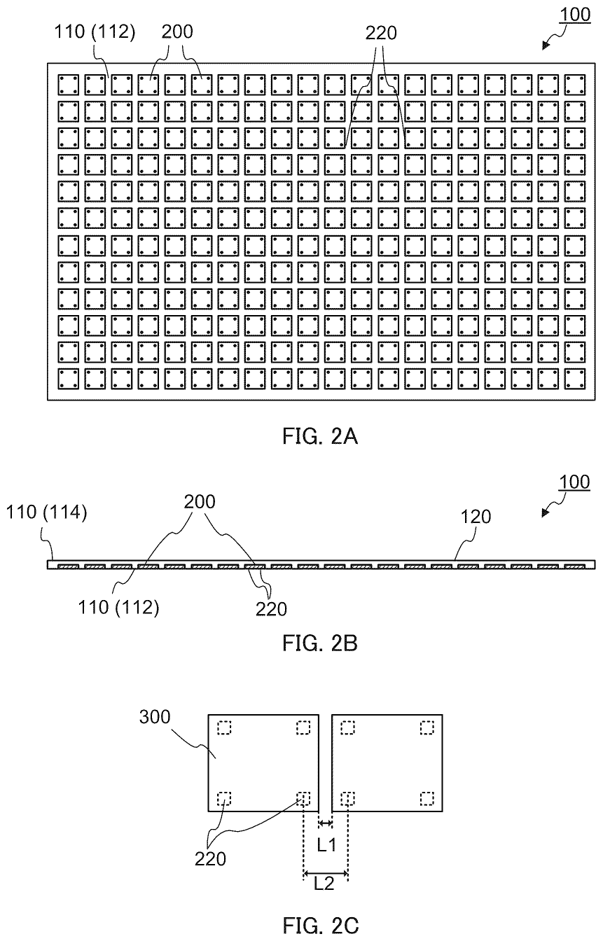

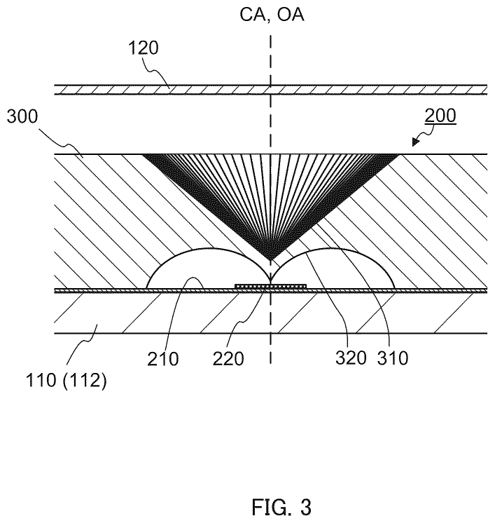

FIGS. 1A and 1B illustrate the configuration of surface light source device 100 according to Embodiment 1 of the present invention. FIG. 1A is a plan view, and FIG. 1B is a front view. FIG. 2A is a cross-sectional view taken along line A-A of FIG. 1B, and FIG. 2B is a cross-sectional view taken along line B-B of FIG. 1A. FIG. 2C is a partially enlarged plan view illustrating the positional relationship between light emitting elements 220 and light flux controlling members 300. FIG. 3 is a partially enlarged cross-sectional view of a part of FIG. 2B.

As illustrated in FIGS. 1A to 3, surface light source device 100 according to the present embodiment includes casing 110, plurality of light emitting devices 200, and light diffusion plate 120. Plurality of light emitting devices 200 are disposed in a grid pattern (in a matrix) on bottom plate 112 of casing 110. The inner surface of bottom plate 112 functions as a diffusive reflection surface. Top plate 114 of casing 110 is provided with an opening. Light diffusion plate 120 is disposed to close the opening, and functions as a light emitting surface. The light emitting surface may have any size which is, for example, about 400 mm× about 700 mm.

As illustrated in FIG. 3, light emitting device 200 is fixed on substrate 210. Substrate 210 is fixed at a predetermined position on bottom plate 112 of casing 110. Each light emitting device 200 includes light emitting elements 220 and light flux controlling member 300.

Light emitting element 220 is a light source of surface light source device 100 and is mounted on substrate 210. Light emitting element 220 is, for example, a light emitting diode (LED). Light emitting element 220 may be of any type. For example, light emitting element 220 (for example, COB type light emitting diode) which emits light from the top surface and side surface(s) is suitably used in light emitting device 200 according to the embodiment of the present invention. The color of the light emitting element 220 may be any color, such as white, blue, and RGB. Light emitting element 220 may have any size, which is preferably 0.1 mm to 0.6 mm, more preferably 0.1 mm to 0.3 mm. In the present invention, using a smaller LED allows obtainment of an optical controlling member that can distribute light more appropriately and causes less color unevenness.

Light flux controlling member 300 is an optical member for controlling the distribution of light emitted from light emitting elements 220, and is fixed on substrate 210. As described below, light flux controlling member 300 includes a plurality of incidence units 310. Light flux controlling member 300 is disposed above plurality of light emitting elements 220 in such a way that central axis CA of each incidence unit 310 (incidence surface 320) coincides with optical axis LA of corresponding light emitting element 220. In light flux controlling member 300 according to the present embodiment, incidence unit 310 (incidence surface 320 and first reflection surface 321) of light flux controlling member 300 is rotationally symmetric. The rotation axis of incidence unit 310 is referred to as “central axis CA of incidence unit 310, incidence surface 320, or first reflection surface 321.” In addition, “optical axis LA of light emitting element 220” means a central light beam of a stereoscopic emission light flux from light emitting element 220. A gap may or may not be formed between substrate 210 with light emitting element 220 mounted thereon and the back surface of light flux controlling member 300 to release the heat generated from light emitting element 220 to the outside.

Light flux controlling member 300 is formed by integral molding. The material of light flux controlling member 300 may be any material that allows light with a desired wavelength to pass therethrough. The material of light flux controlling member 300 is, for example, an optically transparent resin such as polymethylmethacrylate (PMMA), polycarbonate (PC), or an epoxy resin (EP), or glass.

Surface light source device 100 according to the present embodiment has a main feature in the configuration of light flux controlling member 300. The configuration of light flux controlling member 300 will be described in detail below.

Light diffusion plate 120 is a plate-shaped member having a light diffusing property, and transmits light emitted from light emitting device 200 while diffusing the light. Normally, the size of light diffusion plate 120 is substantially the same as that of the display member such as a liquid crystal panel. Light diffusion plate 120 is formed of, for example, an optically transparent resin such as polymethylmethacrylate (PMMA), polycarbonate (PC), polystyrene (PS), or styrene-methylmethacrylate copolymer resin (MS). In order to provide a light diffusing property, minute irregularities are formed in the surface of light diffusion plate 120, or light diffusing members such as beads are dispersed in light diffusion plate 120.

In surface light source device 100 according to the present embodiment, light emitted from each light emitting element 220 is expanded by light flux controlling member 300 so as to illuminate a wide range of light diffusion plate 120. The light emitted from each light flux controlling member 300 is further diffused by light diffusion plate 120. Surface light source device 100 according to the present embodiment thus can uniformly illuminate a planar display member (for example, a liquid crystal panel).

As illustrated in FIGS. 2A and 2C, in the present embodiment, plurality of light emitting elements 220 are disposed in a grid pattern and separated from each other, and plurality of light emitting devices 200 are disposed in a grid pattern and separated from each other. Distance L1 between adjacent light emitting devices 200 may be smaller than half of center-to-center distance L2 of plurality of light emitting elements 220. Herein, “center-to-center distance L2 of plurality of light emitting elements 220” means the center-to-center distance between two light emitting elements 220 respectively belonging to different light emitting devices 200. This configuration allows light flux controlling members 300 to guide light more widely, thereby preventing the space between light emitting devices 200 from becoming dark.

It is also important that there is a gap between adjacent light emitting devices 200, and light emitting devices 200 are disposed so as not to contact each other. If the light emitting devices are not disposed with a gap therebetween, light emitted from the end of a light emitting device may be incident on or reflected by the end of the adjacent light flux controlling member, thereby adversely affecting the light emission quality on the diffusion plate.

### Configuration of Light Flux Controlling Member

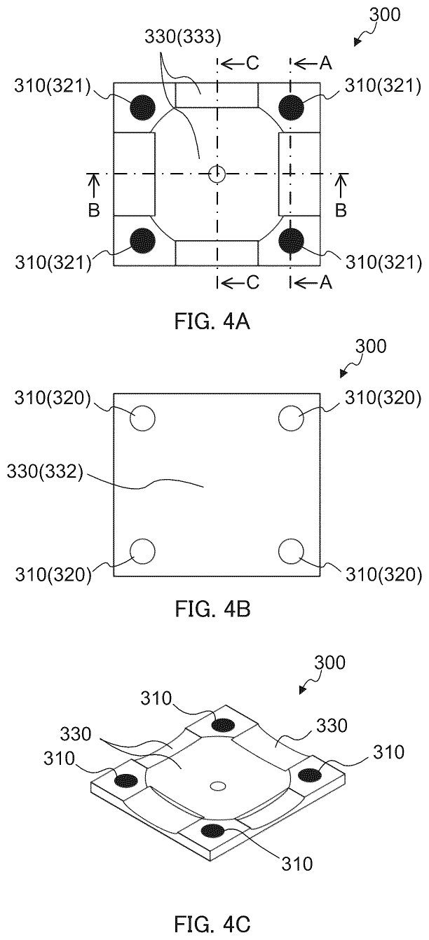

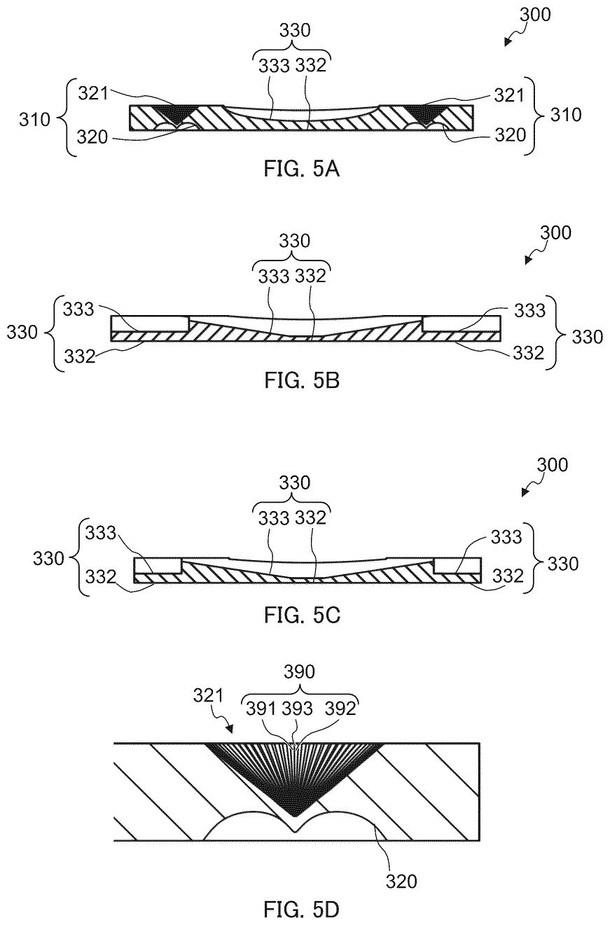

FIG. 4A is a plan view of light flux controlling member 300 according to Embodiment 1, FIG. 4B is a bottom view of light flux controlling member 300, and FIG. 4C is perspective view of light flux controlling member 300. FIG. 5A is a cross-sectional view taken along line A-A of FIG. 4A, FIG. 5B is a cross-sectional view taken along line B-B of FIG. 4A, FIG. 5C is a cross-sectional view taken along line C-C of FIG. 4A, and FIG. 5D is a partially enlarged view of FIG. 5A. Hereinafter, the configuration of light flux controlling member 300 according to Embodiment 1 will be described.

Light flux controlling member 300 according to the present embodiment is for controlling the orientation of light emitted from plurality of light emitting elements 220 disposed on substrate 210. Light flux controlling member 300 includes plurality of incidence units 310 and emission units 330. Plurality of incidence units 310 are disposed in a grid pattern corresponding to the arrangement of light emitting elements 220. Emission unit 330 is disposed between incidence units 310 in the direction along substrate 210.

Each incidence unit 310 allows thereon incidence of light emitted from light emitting element 220. Incidence unit 310 includes incidence surface 320 that allows thereon incidence of light emitted from light emitting element 220, and first reflection surface 321 that reflects the light incident on incidence surface 320 toward emission unit 330.

Incidence surface 320 is an inner surface of a recess disposed on the back side of light flux controlling member 300 and formed at a position facing light emitting element 220. Incidence surface 320 allows the majority of light emitted from light emitting element 220 to enter light flux controlling member 300, while controlling the travelling direction of the light. Incidence surface 320 intersects optical axis LA of light emitting element 220 and is rotationally symmetric (circular symmetric) about optical axis LA. Incidence surface 320 may have any shape which is set in such a way that the light incident on incidence surface 320 is directed toward first reflection surface 321 and first emission surface 333. In the present embodiment, incidence surface 320 has a shape such that the distance from substrate 210 to the surface gradually increases and then gradually decreases as the distance from optical axis LA of light emitting element 220 to the surface increases.

First reflection surface 321 is disposed on the front side of light flux controlling member 300 at a position facing light emitting element 220 with incidence surface 320 located therebetween. First reflection surface 321 laterally reflects light incident on incidence surface 320 in such a way that the reflected light travels away from optical axis LA of light emitting element 220. Herein, “laterally (i.e., lateral direction)” does not refer to a direction toward the outer edge of a light flux controlling member, but refers to a direction directed outward in the radial direction 3600 about the optical axis.

First reflection surface 321 thus can prevent light incident on incidence surface 320 from escaping upward, thereby preventing the generation of a bright part immediately above light emitting element 220. In addition, first reflection surface 321 can also guide the light toward the area between light emitting elements 220, thereby preventing the generation of a dark part between light emitting elements 220. First reflection surface 321 may have any shape, so long as the surface can laterally reflect light incident on incidence surface 320. First reflection surface 321 is configured, for example, to be rotationally symmetric (circularly symmetric) about optical axis LA of light emitting element 220, and to approach the front side (the distance from substrate 210 to the surface increases) as the distance from optical axis LA of light emitting element 220 to the surface increases.

The generatrix of this rotationally symmetric surface from the central part to the outer peripheral part of the surface is a curved line or a straight line inclined with respect to the optical axis of light emitting elements 220. First reflection surface 321 is a concave surface in a state where the generatrix is rotated by 3600 with central axis CA of incidence surface 320 as a rotation axis. In the present embodiment, the generatrix is a straight line.

As illustrated in FIG. 5D, first reflection surface 321 may include plurality of protrusions 390 each disposed so as to connect the central part of the first reflection surface with the outer edge of the first reflection surface. Each protrusion 390 includes first inclined surface 391, second inclined surface 392 disposed in a pair with first inclined surface 391, and ridge line 393—a boundary line between first inclined surface 391 and second inclined surface 392—of the protrusion. Plurality of protrusions 390 are disposed in such a way that a valley is formed between adjacent protrusions 390.

Providing such first reflection surface 321 with protrusions 390 can reflect light incident on incidence surface 320 more efficiently, thus can further prevent light incident on incidence surface 320 from escaping upward.

In the present invention, incidence surface 320 and first reflection surface 321 are inner surfaces of the recesses. In plan view, the area of the opening edge of the recess forming the first reflection surface is preferably 0.5 to 2.0 times, more preferably 0.5 to 1.5 times, particularly preferably 0.5 to 1.3 times, the area of the opening edge of the recess forming the incident surface. That is, the size of the first reflection surface with respect to the incidence surface is smaller than that of a conventional total reflection lens. This configuration comes from the design of the present invention such that light emitted from the center of a light emitting element and incident on the incidence surface is to reach not only the first reflection surface but also the first emission surface.

Emission unit 330 emits light incident on plurality of incidence units 310 while guiding the light. In the present embodiment, on the premise that four incidence units 310 are disposed at individual corners of a virtual quadrangle, light flux controlling member 300 includes the following: four emission units 330 disposed at positions corresponding to the four sides of the virtual quadrangle so that each emission unit is disposed along the corresponding side; and one emission unit 330 disposed so as to be surrounded by the virtual quadrangle. As illustrated in FIGS. 5A to 5C, each emission unit 330 includes second emission surface 332. The second emission surface is disposed on the back side of light flux controlling member 300 and reflects light from first reflection surface 321 of incidence unit 310. Emission unit 330 also includes first emission surface 333. The first emission surface is disposed on the front side of light flux controlling member 300 so as to face second emission surface 332, and reflects a part of light from incidence unit 310 and emits another part of the light.

In addition, emission unit 330 includes an emission promotion part configured to promote the emission of light traveling between second emission surface 332 and first emission surface 333. The emission promotion part is disposed in at least one of second emission surface 332 and first emission surface 333.

As illustrated in FIGS. 5A to 5C, in the present embodiment, the emission promotion part is formed in first emission surface 333, and the distance between first emission surface 333 and second emission surface 332 decreases as the distances to the surfaces from incidence unit 310 increase. Such a configuration allows the light guided from incidence unit 310 is more likely to be emitted from first emission surface 333 as the distance from incidence unit 310 increases.

First emission surface 333 may have any shape. In the present embodiment, four first emission surfaces 333 disposed at positions corresponding to the four sides of the virtual quadrangle are each a concave surface having a curvature in the direction along the corresponding side of the virtual quadrangle and no curvature in the direction perpendicular to this side (see FIGS. 5A to 5C). First emission surface 333 disposed so as to be surrounded by the virtual quadrangle is a concave surface formed by the bottom (located at the top) and a part of the side surface of a truncated cone disposed upside down (see FIGS. 5B and 5C).

The configuration of the emission promotion part is not limited to the above example, so long as the above functions can be exhibited. For example, the emission promotion part may be at least one member selected from the group consisting of concave surfaces, rough surfaces, fresnel surfaces, grooves, and through holes, which is disposed at (in or on) at least one of second emission surface 332 and first emission surface 333.

When the emission promotion part is a concave surface formed on second emission surface 332 or first emission surface 333, the distance between second emission surface 332 and first emission surface 333 decreases as the distances to the surfaces from incidence unit 310 increase, thus light traveling between second emission surface 332 and first emission surface 333 is more likely to be emitted from first emission surface 333. When the emission promotion part is a rough surface formed on second emission surface 332, the light traveling between second emission surface 332 and first emission surface 333 is diffusely reflected rather than specularly reflected on the rough surface, thus the light is more likely to be emitted from first emission surface 333. When the emission promotion part is a rough surface formed on first emission surface 333, the light traveling between second emission surface 332 and first emission surface 333 is diffused while transmitted by the rough surface rather than specularly reflected on the rough surface. The light is thus more likely to be emitted from first emission surface 333. When the emission promotion part is a fresnel surface or one or more grooves formed on or in second emission surface 332, the light traveling between second emission surface 332 and first emission surface 333 is reflected toward first emission surface 333 in such a way that the incidence angle on first emission surface 333 becomes small at the surface constituting the fresnel surface or grooves. The light is thus more likely to be emitted from first emission surface 333. When the emission promotion part is a fresnel surface or one or more grooves formed on or in first emission surface 333, the light traveling between second emission surface 332 and first emission surface 333 is emitted from the surface constituting the fresnel surface or grooves. The light is thus more likely to be emitted from first emission surface 333. When the emission promotion part is one or more through holes each opening onto second emission surface 332 and first emission surface 333, the light traveling between second emission surface 332 and first emission surface 333 is emitted from the surface constituting the through holes. The light is thus more likely to be emitted from first emission surface 333.

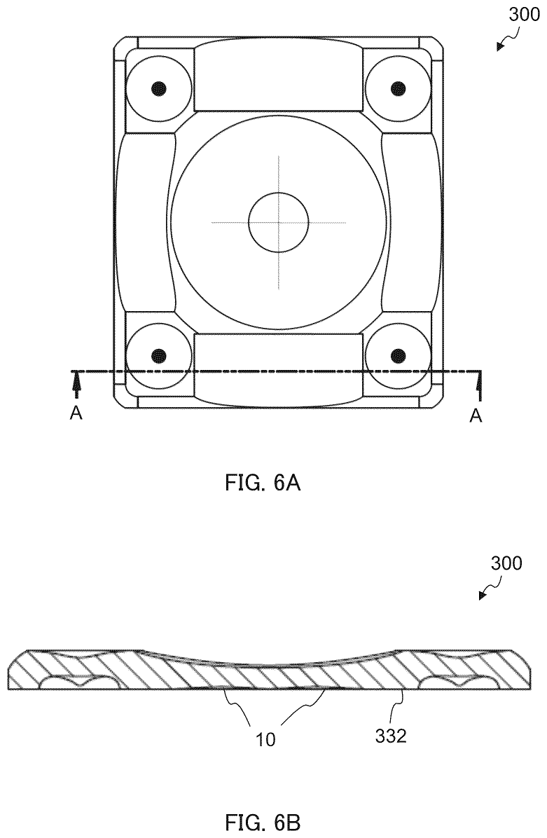

FIGS. 6A to 9B illustrate light flux controlling member 300 for describing modifications of the emission promotion part. These drawings illustrate light flux controlling member 300 in which first reflection surface 321 of incidence unit 310 does not include protrusion 390.

FIGS. 6A and 6B illustrate light flux controlling member 300 in which the emission promotion part is formed on second emission surface 332. The emission promotion part is composed of two concave surfaces 10 each having a substantially triangular shape in the cross-sectional view. FIG. 6A is a plan view of light flux controlling member 300, and FIG. 6B is a cross-sectional view taken along line B-B of FIG. 6A.

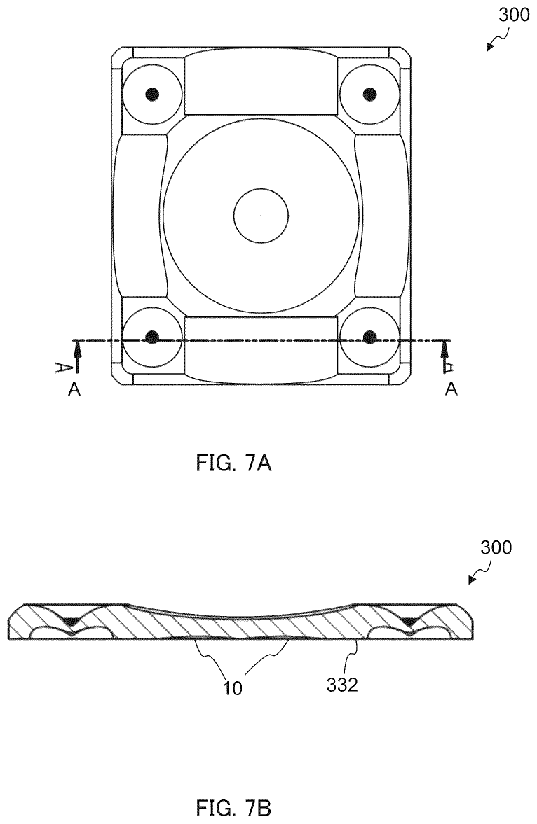

FIGS. 7A and 7B illustrate light flux controlling member 300 in which the emission promotion part is formed on second emission surface 332. The emission promotion part is composed of two concave surfaces 10 each having a shape of a substantial arc in the cross-sectional view. FIG. 7A is a plan view of light flux controlling member 300, and FIG. 7B is a cross-sectional view taken along line B-B of FIG. 7A.

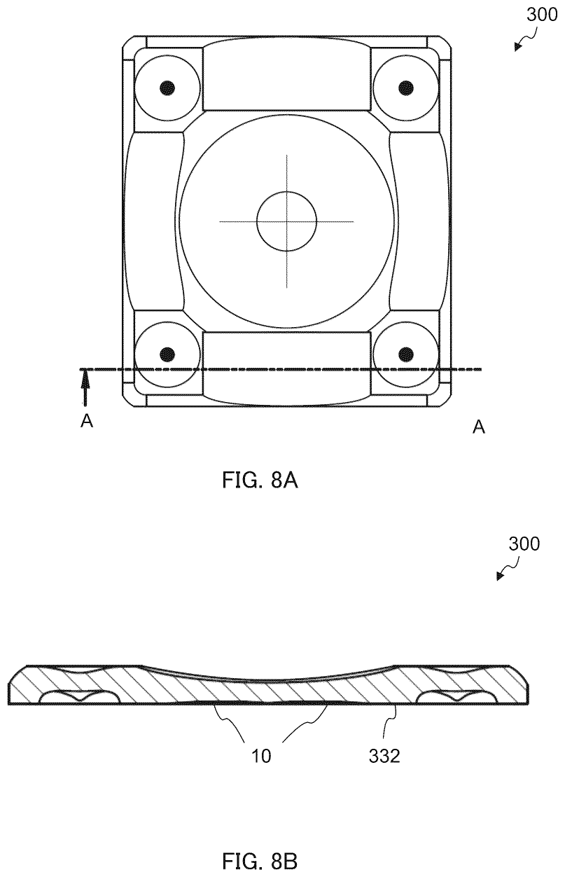

FIGS. 8A and 8B illustrate light flux controlling member 300 in which the emission promotion part is formed on second emission surface 332. The emission promotion part is composed of two concave surfaces 10 each having a substantially trapezoidal shape in the cross-sectional view. FIG. 8A is a plan view of light flux controlling member 300, and FIG. 8B is a cross-sectional view taken along line B-B of FIG. 8A.

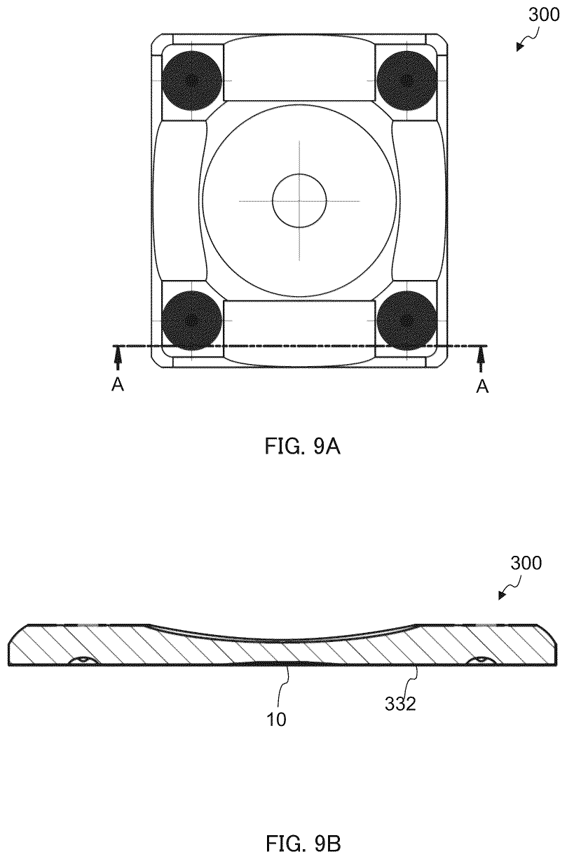

FIGS. 9A and 9B illustrate light flux controlling member 300 in which the emission promotion part is formed on second emission surface 332. The emission promotion part is one concave surface 10 having a substantially trapezoidal shape in the cross-sectional view. FIG. 9A is a plan view of light flux controlling member 300, and FIG. 9B is a cross-sectional view taken along line B-B of FIG. 9A.

### Light Distribution

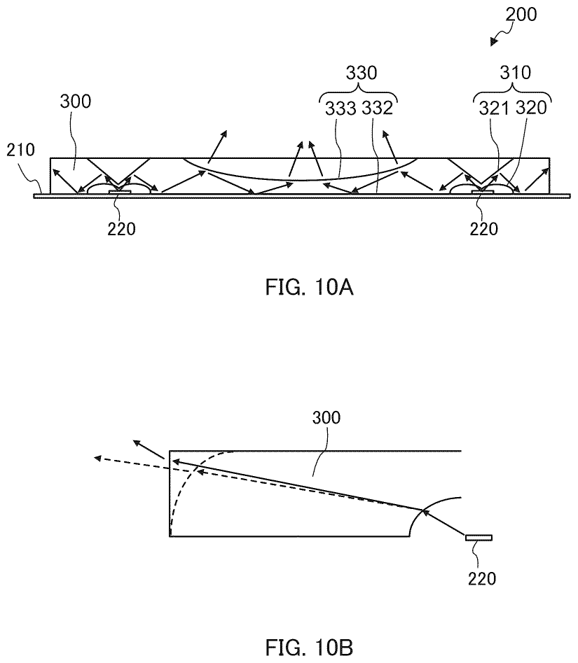

FIG. 10A illustrates optical paths in light emitting device 200. As illustrated in FIG. 10A, light emitted from light emitting element 220 is incident on incidence surface 320 to enter light flux controlling member 300. A part of the light incident on incidence surface 320 is directly directed toward emission unit 330, and another part of the light is reflected by first reflection surface 321 and directed toward emission unit 330. The light having reached emission unit 330 is repeatedly reflected by second emission surface 332 and first emission surface 333 to be guided through emission unit 330. At this time, a part of the light having reached first emission surface 333 is emitted from first emission surface 333 without being reflected.

As a result, the light having reached emission unit 330 travels in emission unit 330 between second emission surface 332 and first emission surface 333, and is gradually emitted from first emission surface 333. In this configuration, emission unit 330 includes the emission promotion part such that the distance between second emission surface 332 and first emission surface 333 decreases as the distances to the surfaces from incidence unit 310 increase. The light traveling between second emission surface 332 and first emission surface 333 is thus more likely to be emitted from first emission surface 333 as the distance from incidence unit 310 increases.

FIG. 10B illustrates the light distribution at the end of light flux controlling member 300. As illustrated in FIG. 10B, the cross-sectional shape of the end of light flux controlling member 300 may be rectangular or chamfered. That is, the outer edge of light flux controlling member 300 may be chamfered on the front side. Examples of the chamfered shape include R chamfered and C chamfered (inclined surface). When the end of light flux controlling member 300 in its cross-section is chamfered, a wide region of the diffusion plate—the region located between the light emitting devices—can be illuminated, thereby preventing the space (gap) between light emitting devices 200 from becoming dark.

### Illuminance Distribution

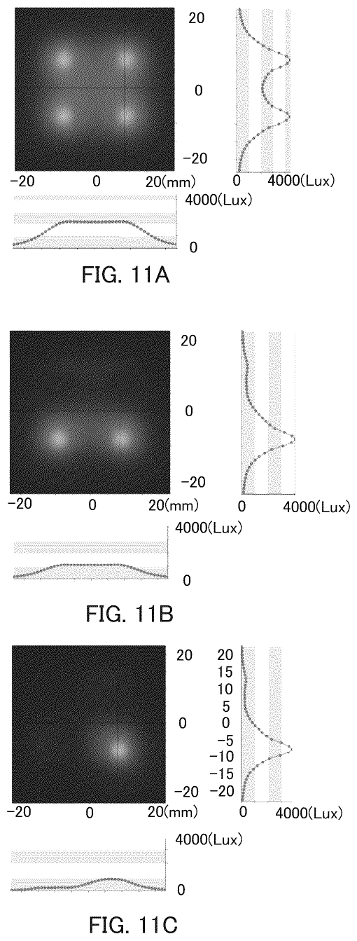

FIGS. 11A to 11C illustrate the illuminance distribution on surface light source device 100 according to the present embodiment. The drawings show the illuminance distribution on light diffusion plate 120 when only one to four light emitting elements 220 included in one light emitting device 200 are turned on in surface light source device 100.

FIG. 11A illustrates the illuminance distribution when all four light emitting elements 220 are turned on. FIG. 11B illustrates the illuminance distribution when the lower two of four light emitting elements 220 are turned on. FIG. 11C illustrates the illuminance distribution when the lower one of four light emitting elements 220 is turned on. In each drawing, the lower graph shows the illuminance distribution in the lateral direction between upper two light emitting elements 220 and lower two light emitting elements 220, and the graph on the right shows the illuminance distribution in the vertical direction passing through the light emitting centers of two light emitting elements 220 on the right.

The graphs show that light flux controlling member 300 according to the present embodiment can expand the light emitted from each light emitting element 220 so as to substantially uniformly illuminate a range corresponding to each light emitting element 220. The graphs also show that light flux controlling member 300 according to the present embodiment allows the light from each light emitting element 220 to reach the region corresponding to each light emitting element 220 without excessively mixing the light with light from another light emitting element 220.

As described above, light flux controlling member 300 according to the present embodiment can prevent excessive expansion of light from the light emitting element 220 while expanding the light to some extent. It is thus easy to increase the illuminance only in a predetermined region associated with each light emitting element 220 (local dimming). The reason therefor is as follows: light flux controlling member 300 includes an emission promotion part in which the distance between second emission surface 332 and first emission surface 333 decreases as the distances to the surfaces from incidence unit 310 increase; and thus the light emitted from one light emitting element 220 is less likely to reach another light emitting element 220 (adjacent light emitting element 220) through emission unit 330.

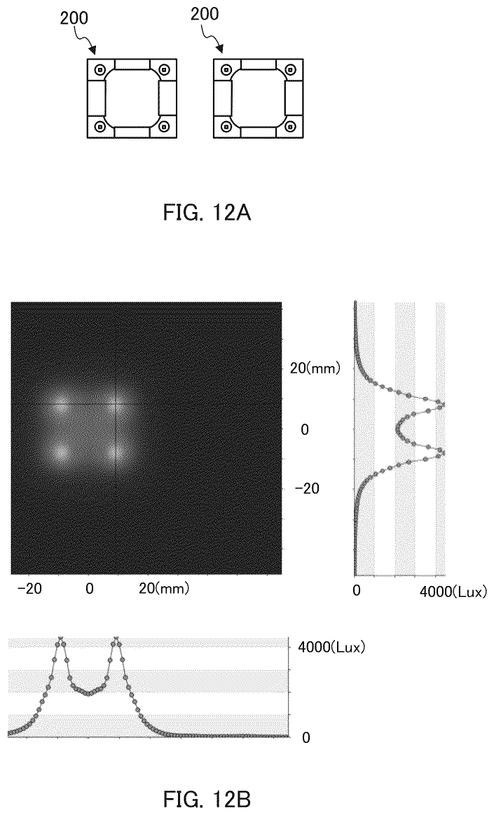

FIG. 12A illustrates two light emitting devices 200 arranged side by side. FIG. 12B illustrates the illuminance distribution, with two light emitting devices 200 arranged side by side as in FIG. 12A, when four light emitting elements 220 of light emitting device 200 on the left side are turned on. In FIG. 12B, the lower graph shows the illuminance distribution in the lateral direction passing through the light emitting centers of upper four light emitting elements 220 of two light emitting devices 200 and the graph on the right shows the illuminance distribution in the vertical direction passing through the light emitting centers of two right side light emitting elements 220 of light emitting device 200 on the left.

The graphs show that the light from light emitting device 200 on the left expands only on light emitting device 200 on the left. By using light emitting device 200 according to the present embodiment, light is not expanded to adjacent light emitting device 200.

### Effect

The use of light flux controlling member 300 according to the present embodiment allows light from plurality of light emitting elements 220 to expand within an appropriate range while preventing the excessive expansion of the light even when the distance between substrate 210 and light diffusion plate 120 is small. Therefore, the present invention is effective for local dimming. In addition, the present invention enables one light flux controlling member 300 to control the light from plurality of light emitting elements 220, thereby facilitating the mounting of light flux controlling member 300.

### Modifications

The above description is for a light flux controlling member including four incidence units 310 to be disposed above four light emitting elements 220. However, the light flux controlling member of the present invention is not limited thereto, so long as the light flux controlling member is used for plurality of light emitting elements 220.

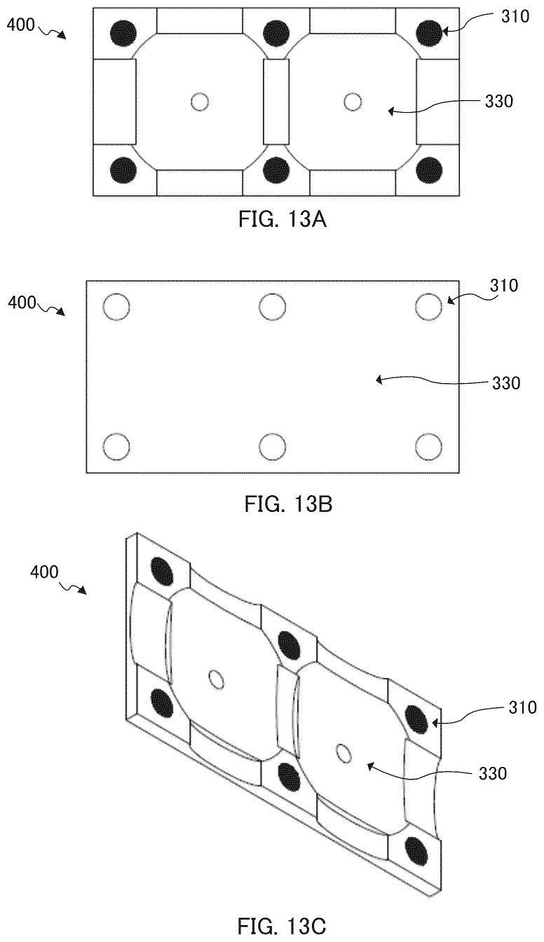

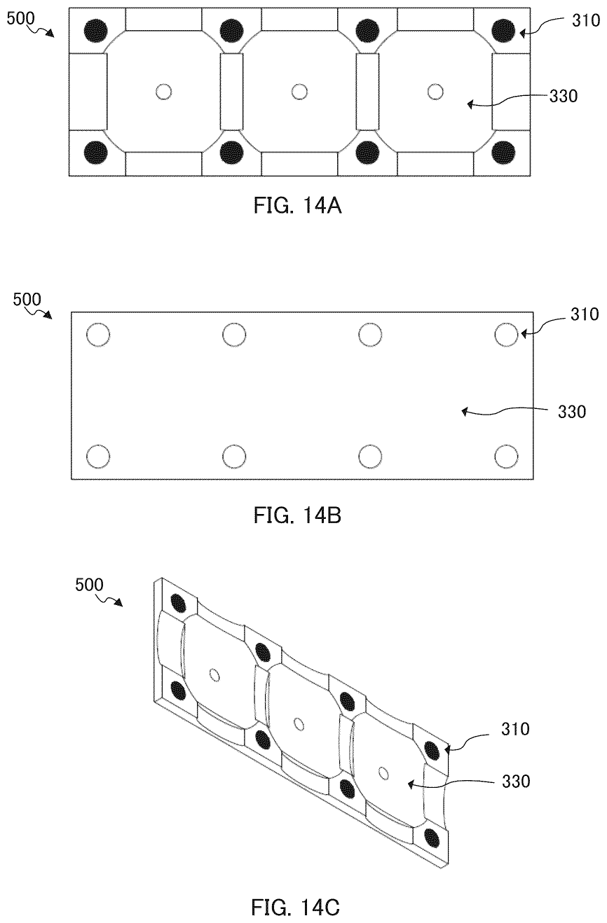

FIGS. 13A, 13B, and 13C are a plan view, a bottom view, and a perspective view of light flux controlling member 400 including six incidence units 310 to be disposed above six light emitting elements 220. FIGS. 14A, 14B, and 14C are a plan view, a bottom view, and a perspective view of light flux controlling member 500 including eight incidence units 310 to be disposed above eight light emitting elements 220. Light flux controlling members 400 and 500 each include incidence units 310 and emission units 330 in the same manner as light flux controlling member 300.

### Effect

Light flux controlling members 400 and 500 according to the modifications have the same effect as light flux controlling member 300. In addition, light flux controlling members 400 and 500 are disposed above a larger number of light emitting elements 220, thereby further facilitating the mounting as compared to light flux controlling member 300.

In the present invention, the optical controlling member may have any shape, such as a square shape, a rectangular shape, a circular shape, or an octagonal shape. For example, it is possible to control the light by forming a notch between incidence units.

In the present invention, the optical controlling member preferably include legs. The presence of the legs can prevent heat of the light emitting element from being trapped and can reduce the optical influence of an adhesive used for bonding the optical controlling member to the substrate.

### Embodiment 2

A surface light source device according to Embodiment 2 differs from surface light source device 100 according to Embodiment 1 only in the configuration of light flux controlling member 600. Therefore, only the configuration of light flux controlling member 600 will be described in Embodiment 2. The same components as those of light flux controlling member 300 according to Embodiment 1 are designated by the same reference numerals, and the description thereof will be omitted.

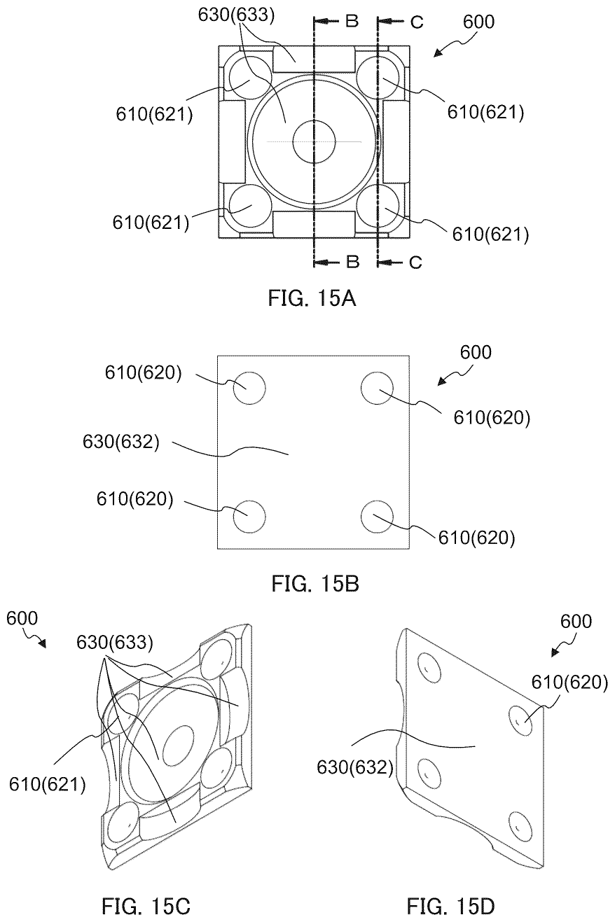

Configuration of Light Flux Controlling Member FIGS. 15A to 15D illustrate light flux controlling member 600 according to Embodiment 2. FIG. 15A is a plan view of light flux controlling member 600 according to Embodiment 2, FIG. 15B is a bottom view of light flux controlling member 600, FIG. 15C is a perspective view of light flux controlling member 600 as viewed from its front side, and FIG. 15D is a perspective view of light flux controlling member 600 as viewed from its back side.

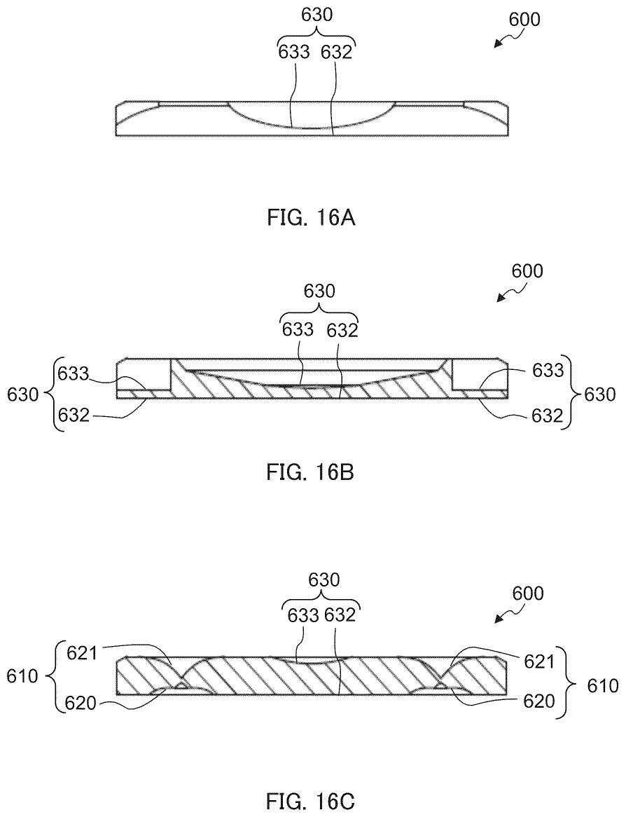

FIG. 16A is a side view of light flux controlling member 600, FIG. 16B is a cross-sectional view taken along line B-B of FIG. 15A, and FIG. 16C is a cross-sectional view taken along line C-C of FIG. 15A. Hereinafter, the configuration of light flux controlling member 600 according to Embodiment 2 will be described.

Light flux controlling member 600 according to the present embodiment is for controlling the orientation of light emitted from plurality of light emitting elements 220 disposed on substrate 210. Light flux controlling member 600 includes plurality of incidence units 610 and emission units 630. Plurality of incidence units 610 are disposed in a grid pattern corresponding to the arrangement of light emitting elements 220. Emission unit 630 is disposed between incidence units 610 in the direction along substrate 210.

Each incidence unit 610 allows thereon incidence of light emitted from light emitting element 220. Incidence unit 610 includes incidence surface 620 that allows thereon incidence of light emitted from light emitting element 220, and first reflection surface 621 that reflects the light incident on incidence surface 620 toward emission unit 330.

Incidence surface 620 is an inner surface of a recess disposed on the back side of light flux controlling member 600 and formed at a position facing light emitting element 220. Incidence surface 620 allows the majority of light emitted from light emitting element 220 to enter light flux controlling member 600, while controlling the travelling direction of the light. Incidence surface 620 intersects optical axis LA of light emitting element 220 and is rotationally symmetric (circular symmetric) about optical axis LA. In the present embodiment, the recess forming incidence surface 620 has a shape such that a small deep recess is disposed in the central part of a large shallow recess. The small deep recess in the central part has a shape in which the distance from substrate 210 to the recess gradually decreases as the distance from optical axis LA of light emitting element 220 to the recess increases. A part of incidence surface 620—the part formed by the small recess-controls light emitted from light emitting element 220 in such a way that light emitted from light emitting element 220 at a small angle with respect to optical axis LA is also directed toward a region other than the central part of first reflection surface 621. The large recess located around the small recess has a shape in which the distance from substrate 210 to the recess is substantially constant for a while and then gradually decreases as the distance from optical axis LA of light emitting element 220 to the recess increases. A part of incidence surface 620—the part formed by the large recess-controls light emitted from light emitting element 220 in such a way that light emitted from light emitting element 220 at a large angle with respect to optical axis LA is directed toward first emission surface 633.

First reflection surface 621 is disposed on the front side of light flux controlling member 600 at a position facing light emitting element 220 with incidence surface 620 located therebetween. First reflection surface 621 laterally reflects light incident on incidence surface 620 in such a way that the reflected light travels away from optical axis LA of light emitting element 220. In the present embodiment, first reflection surface 621 is rotationally symmetric (circularly symmetric) about optical axis LA of light emitting element 220, and configured to approach the front side as the distance from optical axis LA of light emitting element 220 to the surface increases. In the present embodiment, the generatrix of this rotationally symmetric surface from the central part to the outer peripheral part of the surface is a curved line such that the angle between the generatrix and optical axis LA increases as the distance from optical axis LA of light emitting element 220 to the generatrix increases. First reflection surface 621 is a concave surface in a state where the generatrix is rotated by 3600 with central axis CA of incidence surface 620 as a rotation axis. In the present embodiment, first reflection surface 621 does not include plurality of protrusions to be disposed so as to connect the central part of the first reflection surface with the outer edge of the first reflection surface.

In the present embodiment, incidence surface 620 and first reflection surface 621 are configured in such a way that light emitted from the center of light emitting element 220 is incident on incidence surface 620, reflected by first reflection surface 621, and then reaches first emission surface 633 of emission unit 630.

Emission unit 630 emits light incident on plurality of incidence units 610 while guiding the light. In the present embodiment, on the premise that four incidence units 610 are disposed at individual corners of a virtual quadrangle, light flux controlling member 600 includes four emission units 630 disposed at positions corresponding to the four sides of the virtual quadrangle in such a way that each emission unit is disposed along the corresponding side, and one emission unit 630 disposed so as to be surrounded by the virtual quadrangle. Each emission unit 630 includes second emission surface 632. The second emission surface is disposed on the back side of light flux controlling member 600 and reflects light from incidence unit 610. Emission unit 630 also includes first emission surface 633 and an emission promotion part. The first emission surface is disposed on the front side of light flux controlling member 600 so as to face second emission surface 632, and reflects a part of light from incidence unit 610 and emits another part of the light. The emission promotion part is configured to promote the emission of light, traveling between second emission surface 632 and first emission surface 633, from first emission surface 633.

In the present embodiment, second emission surface 632 is a flat surface (see FIG. 15B). In addition, four first emission surfaces 633 disposed at positions corresponding to the four sides of the virtual quadrangle are each a concave surface having a curvature in the direction along the corresponding side of the virtual quadrangle and no curvature in the direction perpendicular to this side (see FIG. 15C). First emission surface 633 disposed so as to be surrounded by the virtual quadrangle is a concave surface formed by the bottom (located at the top) and a part of the side surface of a truncated cone disposed upside down (see FIGS. 15A, 15C, and 16B).

As described above, plurality of incidence units 610 are disposed in a grid pattern corresponding to the arrangement of light emitting elements 220. Regarding emission unit 630 disposed between two adjacent incidence units 610 in the diagonal direction of the grid, the emission promoting part in the emission unit is a concave surface (see FIG. 16B). Regarding emission unit 630 located between two adjacent incidence units 610 in the side direction of the grid, the emission promotion part in the emission unit is a concave surface or one or more grooves. In the present embodiment, the emission promotion part in emission unit 630, which is located between two adjacent incidence units 610 in the side direction of the grid, is a concave surface.

In addition, in the present embodiment, the outer edge of light flux controlling member 600 is R chamfered on the front side (see FIG. 10B).

### Light Distribution

In light flux controlling member 600 according to the present embodiment, light emitted from light emitting element 220 is incident on incidence surface 620 to enter light flux controlling member 600 as in light flux controlling member 300. A part of the light incident on incidence surface 620 is directly directed to emission unit 630, and another part of the light is reflected by first reflection surface 621 and directed toward emission unit 630. The light having reached emission unit 630 is repeatedly reflected by second emission surface 632 and first emission surface 633 to be guided through emission unit 630. At this time, a part of the light having reached first emission surface 633 is emitted from first emission surface 633 without being reflected.

As a result, the light having reached emission unit 630 travels in emission unit 630 between second emission surface 632 and first emission surface 633, and is gradually emitted from first emission surface 633. Emission unit 630 includes the above emission promotion part. The light traveling between second emission surface 632 and first emission surface 633 is thus more likely to be emitted from first emission surface 633 as the distance from incidence unit 610 increases.

### Illuminance Distribution

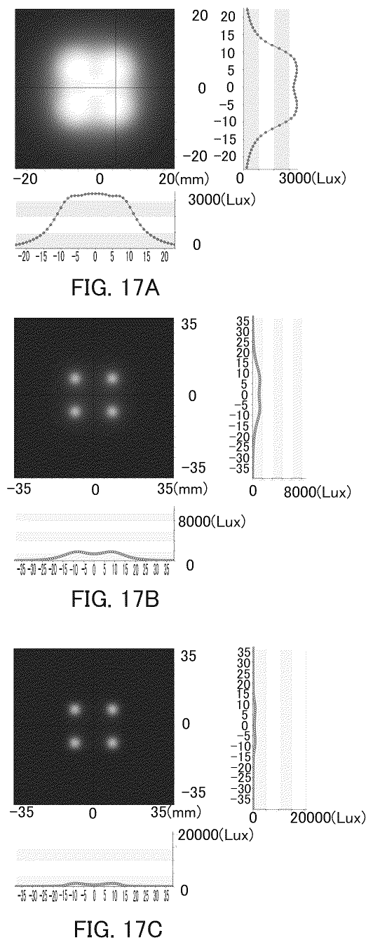

FIG. 17A illustrates the illuminance distribution on surface light source device 100 with the use of light flux controlling member 600 according to the present embodiment. FIG. 17B illustrates for comparison the illuminance distribution of a surface light source device with no light flux controlling member 600 disposed (only light emitting elements 220 are disposed). FIG. 17C illustrates for comparison the illuminance distribution of a surface light source device with a transparent resin flat plate having substantially the same size being disposed in place of light flux controlling member 600. Each drawing shows the illuminance distribution on light diffusion plate 120 when four light emitting elements 220 included in one light emitting device are turned on in the surface light source device. In each drawing, the lower graph shows the illuminance distribution in the lateral direction between upper two light emitting elements 220 and lower two light emitting elements 220, and the graph on the right shows the illuminance distribution in the vertical direction passing through the light emitting centers of two light emitting elements 220 on the right.

The graphs show that light flux controlling member 600 according to the present embodiment can expand the light emitted from each light emitting element 220 so as to substantially uniformly illuminate a range corresponding to each light emitting element 220. The graphs also show that light flux controlling member 600 according to the present embodiment allows the light from each light emitting element 220 to reach the region corresponding to each light emitting element 220 without excessively mixing the light with light from another light emitting element 220.

### Effect

In addition to the effect of light flux controlling member 300 according to Embodiment 1, light flux controlling member 600 according to the present embodiment has the following effects: light is less likely to escape to an area immediately above light emitting element 220; and light is more likely to travel between light emitting elements 220.

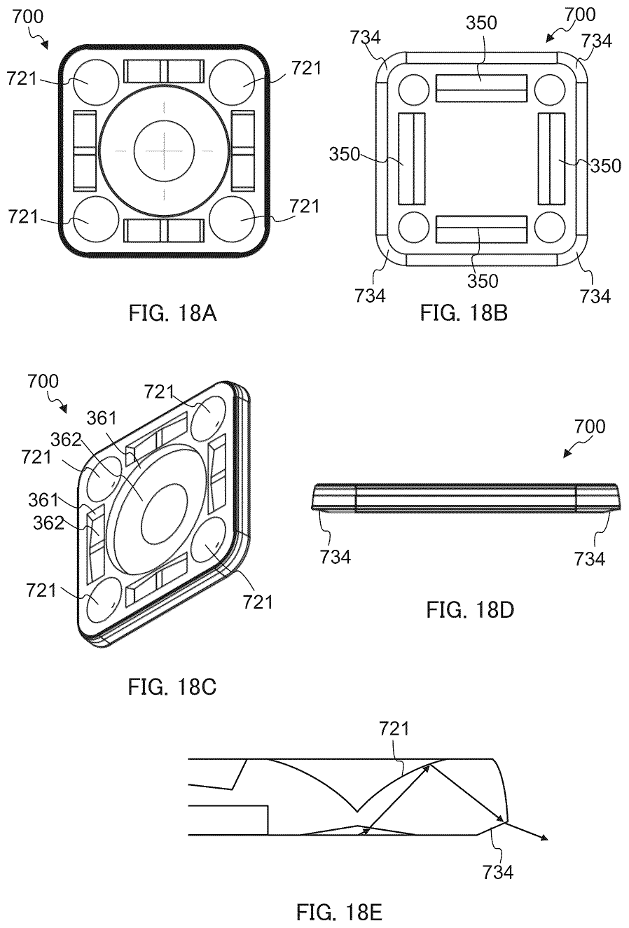

Modifications of Outer peripheral part of Light Flux Controlling Member FIGS. 18A to 18E illustrate a modification of the configuration of the outer peripheral part of a light flux controlling member. The outer peripheral part is applicable to any light flux controlling member of the present invention. The configuration of the outer peripheral part will be described with reference to light flux controlling member 700 as an example. The outer peripheral part is configured in such a way that light reflected by first reflection surface 721 toward the outer peripheral part of light flux controlling member 700 can be appropriately emitted from the outer peripheral part of light flux controlling member 700.

FIGS. 18A to 18E illustrate light flux controlling member 700 including third emission surface 734 disposed at the outer peripheral part of light flux controlling member 700 so as to face first reflection surface 721.

Regarding light flux controlling member 700, FIG. 18A illustrates a plan view, FIG. 18B illustrates a bottom view, FIG. 18C illustrates a perspective view, FIG. 18D illustrates a side view, and FIG. 18E illustrates a cross-sectional view. In FIG. 18E, hatching is omitted to show optical paths.

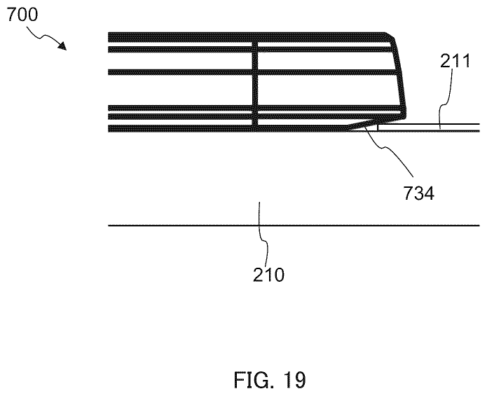

As illustrated in FIG. 18E, third emission surface 734 is disposed at the outer peripheral part of light flux controlling member 700 so as to face first reflection surface 721. More specifically, third emission surface 734 is disposed between the side surface and the back surface in light flux controlling member 700. This configuration allows a part of light—the light reflected by first reflection surface 721 toward the outer peripheral part of light flux controlling member 700—is appropriately emitted from third reflection surface 734 disposed at the outer peripheral part of light flux controlling member 700 without becoming stray light. Light flux controlling member 700 including third emission surface 734 forms a gap at the outer peripheral part of light flux controlling member 700 between light flux controlling member 700 (third emission surface 734) and substrate 210. As a result, as illustrated in FIG. 19, third emission surface 734 can press reflective sheet 211 disposed on substrate 210, and thus reflective sheet 211 is not necessarily bonded to substrate 210.

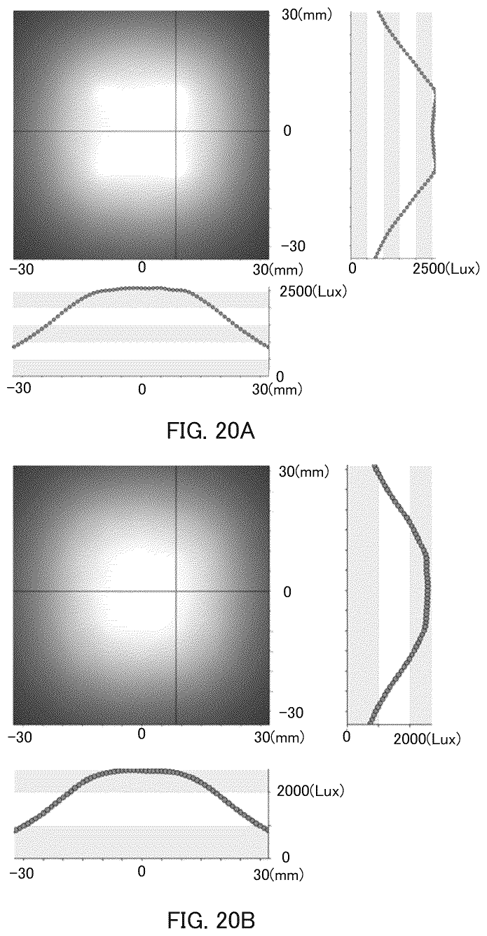

FIG. 20A illustrates the illuminance distribution on surface light source device 100 with the use of a light flux controlling member including no third emission surface 734. FIG. 20B illustrates the illuminance distribution on surface light source device 100 with the use of light flux controlling member 700 including third emission surface 734. The drawings show the illuminance distribution on light diffusion plate 120 when only four light emitting elements 220 included in one light emitting device are turned on in surface light source device 100. In each drawing, the lower graph shows the illuminance distribution in the lateral direction between upper two light emitting elements 220 and lower two light emitting elements 220, and the graph on the right shows the illuminance distribution in the vertical direction passing through the light emitting centers of two light emitting elements 220 on the right.

The comparison between FIGS. 20A and 20B shows the following: light flux controlling member 700 illustrated FIG. 20B allows the light reflected by first reflection surface 721 toward the outer peripheral part of light flux controlling member 700 to be appropriately emitted from third emission surface 734 without becoming stray light; and thus the area immediately above first reflection surface 721 does not become excessively bright.

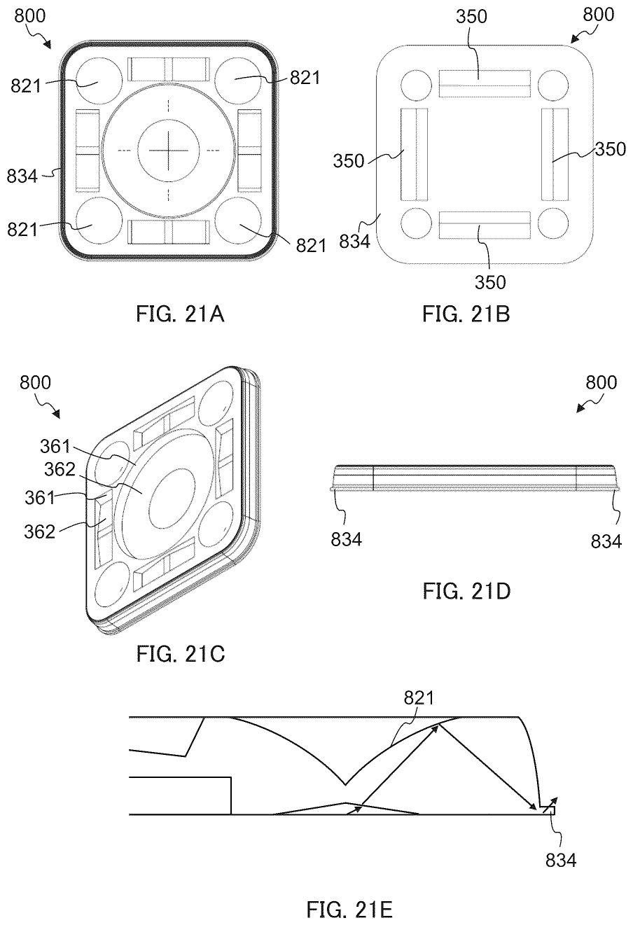

FIGS. 21A to 21E illustrate another modification of the configuration of the outer peripheral part of a light flux controlling member. The outer peripheral part is applicable to any light flux controlling member of the present invention. The configuration of the outer peripheral part will be described with reference to light flux controlling member 800 as an example. The outer peripheral part is configured in such a way that light reflected by first reflection surface 821 toward the outer peripheral part of light flux controlling member 800 can be appropriately emitted from the outer peripheral part of light flux controlling member 800.

FIGS. 21A to 21E illustrate light flux controlling member 800 including flange 834 disposed so as to protrude from the lower part of the side surface of light flux controlling member 800 in a direction along substrate 210.

Regarding light flux controlling member 800, FIG. 21A illustrates a plan view, FIG. 21B illustrates a bottom view, FIG. 21C illustrates a perspective view, FIG. 21D illustrates a side view, and FIG. 21E illustrates a cross-sectional view. In FIG. 21E, hatching is omitted to show optical paths.

As illustrated in FIGS. 21D and 21E, flange 834 is disposed at the lower part of the outer peripheral part of light flux controlling member 800. More specifically, flange 834 is disposed so as to protrude from the lower part of the side surface of light flux controlling member 800 in a direction along substrate 210. This configuration allows a part of light—the light reflected by first reflection surface 821 toward the outer peripheral part of light flux controlling member 800—to be appropriately emitted from the surface of flange 834 disposed at the outer peripheral part of light flux controlling member 800 without becoming stray light, as illustrated in FIG. 21E.

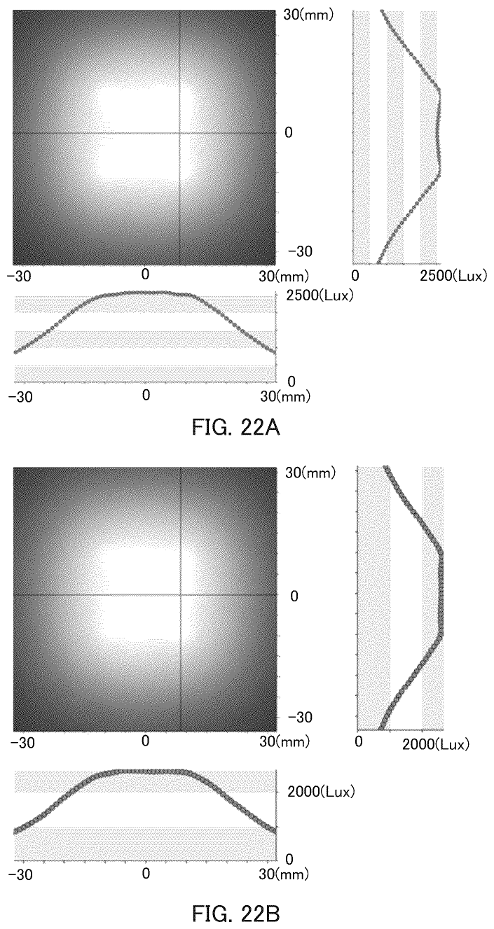

FIG. 22A illustrates the illuminance distribution on surface light source device 100 with the use of a light flux controlling member including no flange 834. FIG. 22B illustrates the illuminance distribution on surface light source device 100 with the use of light flux controlling member 800 including flange 834. The drawings show the illuminance distribution on light diffusion plate 120 when only four light emitting elements 220 included in one light emitting device are turned on in surface light source device 100. In each drawing, the lower graph shows the illuminance distribution in the lateral direction between upper two light emitting elements 220 and lower two light emitting elements 220, and the graph on the right shows the illuminance distribution in the vertical direction passing through the light emitting centers of two light emitting elements 220 on the right.

The comparison between FIGS. 22A and 22B shows the following: light flux controlling member 800 illustrated FIG. 22B allows the light reflected by first reflection surface 821 toward the outer peripheral part of light flux controlling member 800 to be appropriately emitted from flange 834 without becoming stray light; and thus the area immediately above first reflection surface 821 does not become excessively bright.

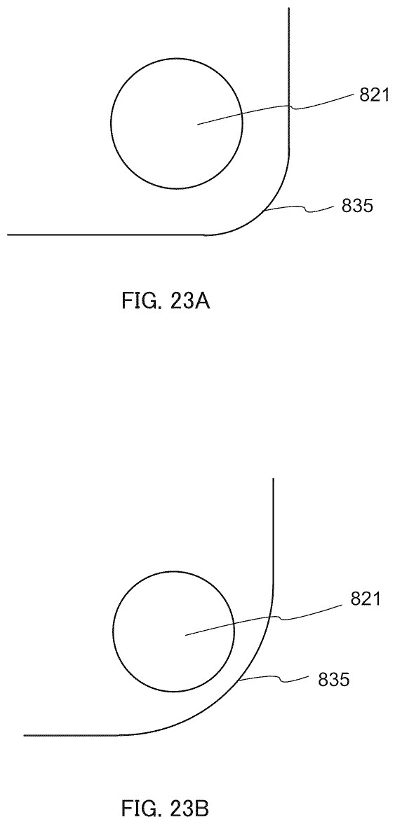

In addition, the following is preferred as illustrated in, for example, FIG. 23A: when a light flux controlling member is viewed in plan view, first reflection surface 821 has a circular shape; and a part of a circle sharing the same center with the outer edge of first reflection surface 821 forms the outer edge of the light flux controlling member. There is thus a portion where the two curves are parallel. Herein, two curves being parallel means that the distance between the two curves is constant. For example, the following is preferred: the circle forming the outer edge of first reflection surface 821 and the arc forming a part of outer edge 835 of the front surface of the light flux controlling member have a concentric relationship. A light flux controlling member having such a configuration is more likely to allow light reflected by first reflection surface 821 toward the outer peripheral part (particularly the corner part) of the light flux controlling member to be appropriately emitted from the outer peripheral part (particularly the corner part) of the light flux controlling member. FIG. 23B illustrates the case where the outer edge of first reflection surface 821 and a part of outer edge 835 of the front surface of a light flux controlling member do not share the same circle center, for comparison.

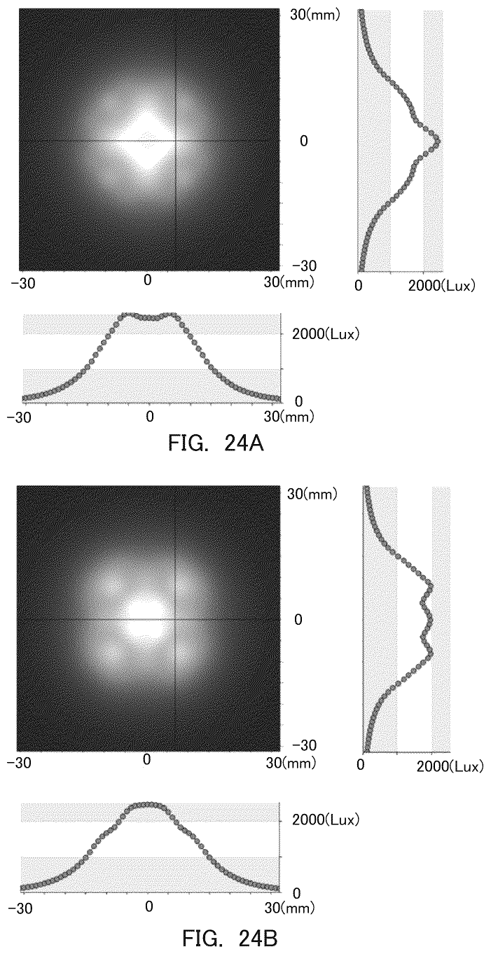

FIG. 24A illustrates the illuminance distribution on surface light source device 100 with the use of a light flux controlling member in which the outer edge of first reflection surface 821 is not parallel with outer edge 835 of the light flux controlling member. FIG. 24B illustrates the illuminance distribution on surface light source device 100 with the use of a light flux controlling member in which the outer edges are parallel. The drawings show the illuminance distribution on light diffusion plate 120 when only four light emitting elements 220 included in one light emitting device are turned on in surface light source device 100. In each drawing, the lower graph shows the illuminance distribution in the lateral direction between upper two light emitting elements 220 and lower two light emitting elements 220, and the graph on the right shows the illuminance distribution in the vertical direction passing through the light emitting centers of two light emitting elements 220 on the right.

The comparison between FIGS. 24A and 24B shows the following: the light flux controlling member illustrated FIG. 24B allows the light reflected by first reflection surface 821 toward the outer peripheral part (particularly the corner part) of the light flux controlling member to be uniformly emitted from the outer peripheral part (corner part) of the light flux controlling member without becoming stray light.

### Effect

The light flux controlling members according to the modifications each allow light reflected by first reflection surface 821 toward the outer peripheral part of the light flux controlling member to be more appropriately emitted without becoming stray light.

In addition, in the light flux controlling member of the present invention, the emission promotion part located in the second emission surface may include light beam direction changing part 350 as illustrated in FIGS. 18B and 21B. The light beam direction changing part includes at least one inclined surface that changes the traveling direction of the incident light. Light beam direction changing part 350 may be disposed between two adjacent incidence units in the side direction of the grid, or between two adjacent incidence units in the diagonal direction of the grid. In FIGS. 18C and 21C, the light beam direction changing part is disposed between two adjacent incidence units in the side direction of the grid.

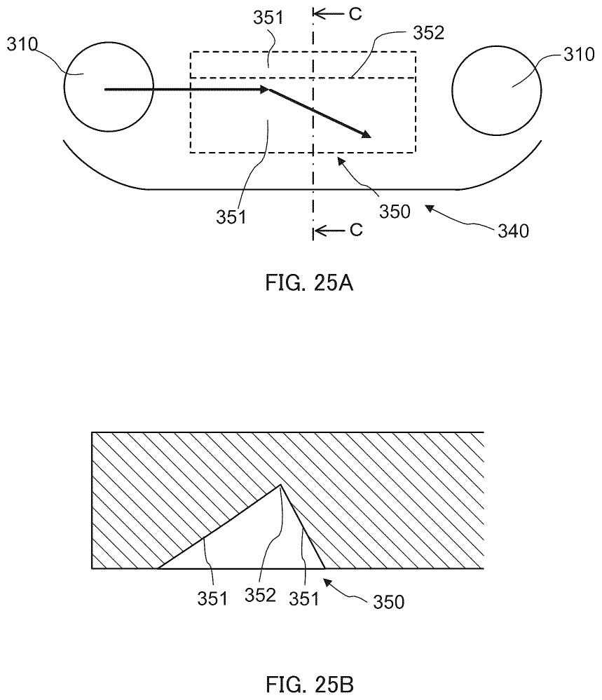

FIG. 25A is an enlarged view of light beam direction changing part 350, and FIG. 25B is a cross-sectional view taken along line B-B of FIG. 25A. As illustrated in FIGS. 25A and 25B, light beam direction changing part 350 includes two inclined surfaces 351 and also ridge line 352 formed between the inclined surfaces. When a emission promotion part includes light beam direction changing part 350, light traveling through the emission promotion part hits inclined surface 351, thereby changing the direction of the light as illustrated in FIG. 25A.

In addition, in the light flux controlling member of the present invention, the emission promotion part located in the first emission surface may include fourth emission surface 361 as illustrated in FIGS. 18C and 21C. Fourth emission surface 361 is disposed on the front side of the light flux controlling member so as to face the first reflection surfaces, and is configured to emit, to the outside of the light flux controlling member, light laterally reflected by first reflection surface. Further, the light flux controlling member may include re-incidence surface 362 located on the front side of the light flux controlling member as illustrated in FIGS. 18C and 21C. The re-incidence surface is located farther to the first reflection surface than fourth emission surface 361 is, and allows the light emitted from fourth emission surface 361 to enter the light flux controlling member again toward light beam direction changing part 350. As illustrated in FIGS. 18C and 21C, fourth emission surface 361 and re-incidence surface 362 may be disposed between two adjacent incidence units in the side direction of the grid, or between two adjacent incidence units in the diagonal direction of the grid.

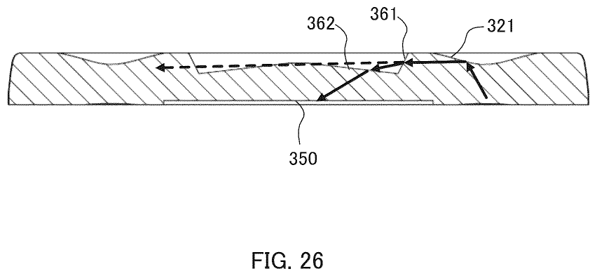

FIG. 26 is an enlarged cross-sectional view illustrating fourth emission surface 361 and re-incidence surface 362. The solid line shows how a light beam travels when there is fourth emission surface 361 and re-incidence surface 362. On the other hand, the broken line shows how the light beam would travel if there is no fourth emission surface and no re-incidence surface. FIG. 26 shows that, with fourth emission surface 361 and re-incidence surface 362 present, light reflected by first reflection surface 321 is emitted from fourth emission surface 361 and incident on re-incidence surface 362. That is, when viewed in cross section, the light does not travel linearly, and is more likely to hit light beam direction changing part 350, facilitating the change of the light direction.

### Modifications of Incidence Surface and First Reflection Surface

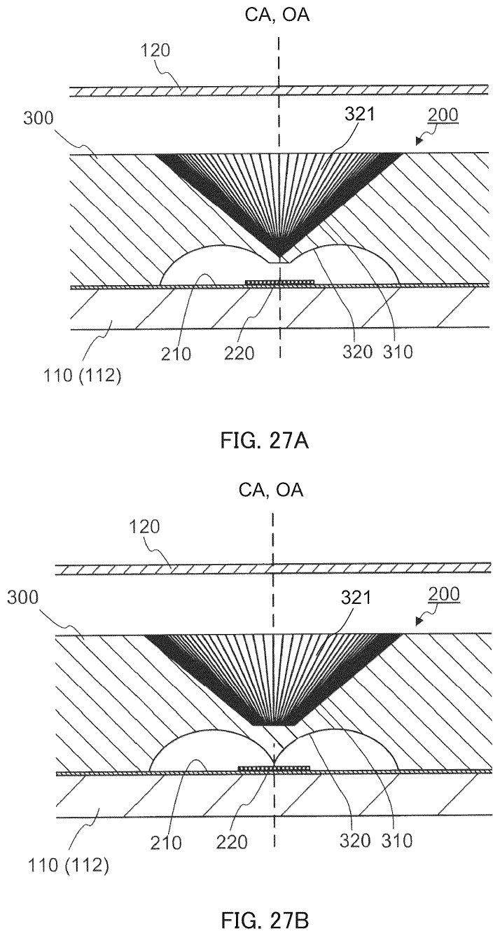

FIGS. 27A to 31B illustrate modifications of the configurations of the incidence surface and first reflection surface applicable to any light flux controlling member of the present invention. The configurations of the surfaces will be described with reference to light flux controlling members 300, 600 and 700 as examples.

FIG. 27A illustrates a modification of incidence surface 320 of light flux controlling member 300. FIG. 27B illustrates a modification of first reflection surface 321 of light flux controlling member 300. In light flux controlling member 300 illustrated in FIGS. 27A and 27B, first reflection surface 321 includes protrusions.

As illustrated in FIG. 27A, incidence surface 320 in the modification includes a substantially flat part at a portion intersecting central axis CA. The center of the flat part is preferably superposed on central axis CA when light flux controlling member 300 is viewed in plan view. Further, the flat part is preferably perpendicular to central axis CA. Incidence surface 320 including a substantially flat part allows a part of light emitted from light emitting element 220 to pass through the flat part to brighten an area located in the vicinity of and immediately above light emitting element 220.

In addition, as illustrated in FIG. 27B, first reflection surface 321 in the modification may include a substantially flat part at a portion intersecting central axis CA. The center of the flat part is preferably superposed on central axis CA when light flux controlling member 300 is viewed in plan view. Further, the flat part is preferably perpendicular to central axis CA. First reflection surface 321 including a substantially flat part allows a part of light emitted from light emitting element 220 to pass through the flat part to brighten an area located in the vicinity of and immediately above light emitting element 220.

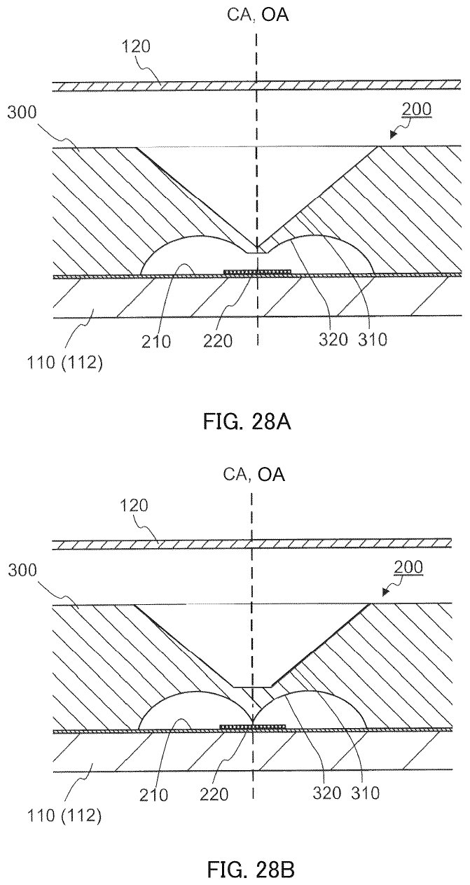

In the similar manner, regarding light flux controlling member 300 whose reflection surface 321 does not include protrusions, FIG. 28A illustrates a modification with incidence surface 320 including a substantially flat part and FIG. 28B illustrates a modification with first reflection surface 321 including a substantially flat part.

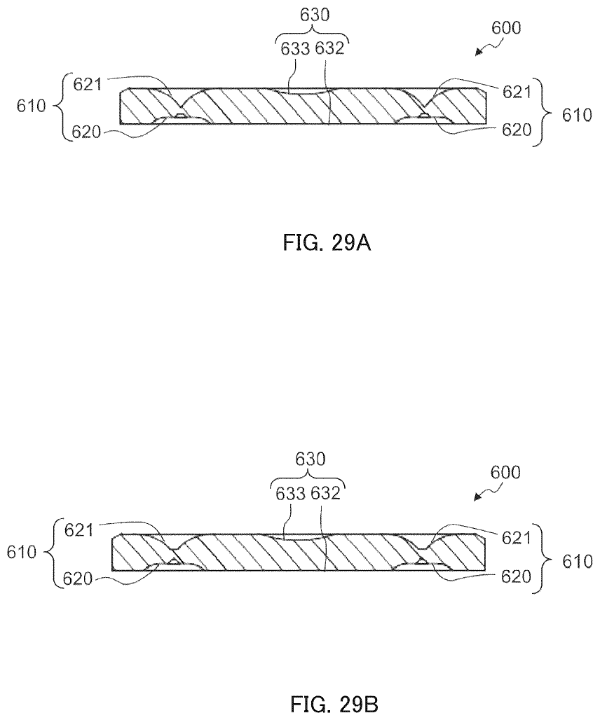

In the similar manner, regarding light flux controlling member 600, FIG. 29A illustrates a modification with incidence surface 620 including a substantially flat part and FIG. 29B illustrates a modification with first reflection surface 621 including a substantially flat part.

In light flux controlling member 600, the recess forming incidence surface 620 has a shape such that a small deep recess is disposed in the central part of a large shallow recess. In the present embodiment, the substantially flat part is formed at the small deep recess as illustrated in FIG. 29A. The following configuration is also possible: no small deep recess is disposed in the central part of the large shallow recess, and the substantially flat part is formed in the central part of the large shallow recess.

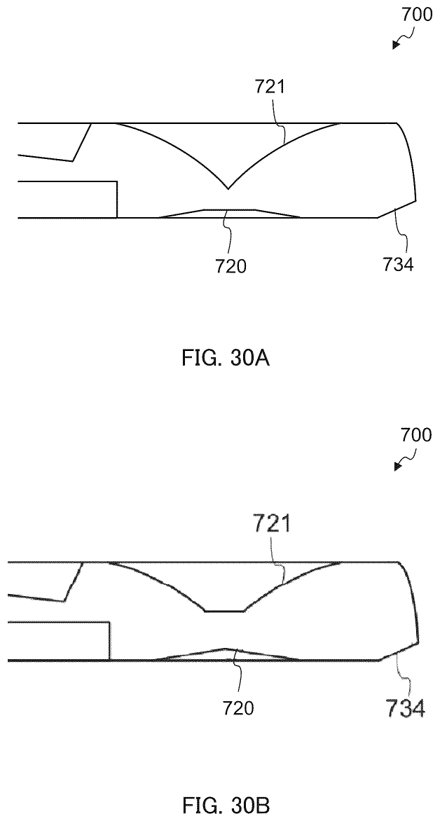

In the similar manner, regarding light flux controlling member 700, FIG. 30A illustrates a modification with incidence surface 720 including a substantially flat part and FIG. 30B illustrates a modification with first reflection surface 721 including a substantially flat part.

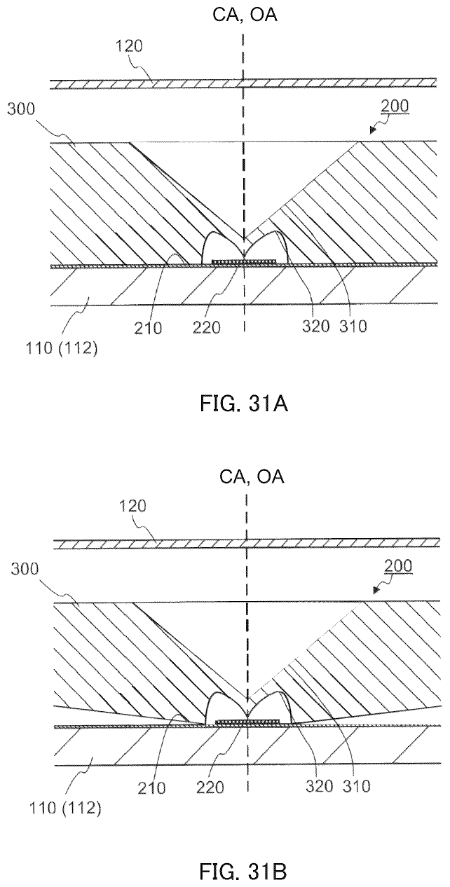

FIGS. 31A and 31B illustrate modifications in which the opening diameter of the recess forming incidence surface 320 is small in light flux controlling member 300.

As illustrated in FIG. 31A, incidence surface 320 is positioned close to the side surface of light emitting element 220 in the modifications (see FIG. 3 for comparison). Positioning incidence surface 320 close to the side surface of light emitting element 220 allows light emitted from the side surface of light emitting element 220 to immediately enter light flux controlling member 300, thereby appropriately controlling the distribution of the light.

In addition, in the modification illustrated in FIG. 31B, an inclined surface is provided on the back surface of light flux controlling member 300 around the recess forming incidence surface 320. This inclined surface extends outward from the opening edge of the recess forming incidence surface 320, and is inclined in such a way that the distance from substrate 210 to the surface increases as the distance from optical axis LA to the surface increases. This inclined surface reflects light emitted from the side surface of light emitting element 220 toward the front side of light flux controlling member 300. Adjusting the angle or the like of this inclined surface can control the distribution of the light emitted from the side surface of light emitting element 220 and entering light flux controlling member 300. In addition, light flux controlling member 300 including the inclined surface allows the formation of a large space between substrate 210 and light flux controlling member 300.

### Method for Mounting Light Flux Controlling Member

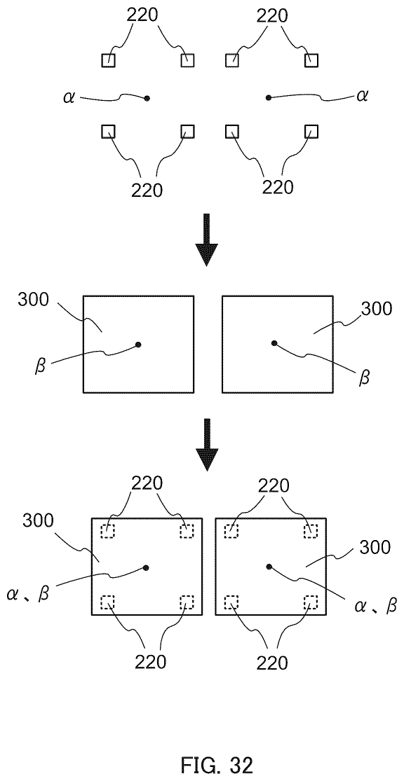

In the following, a method for mounting a light flux controlling member according to the present invention on substrate 210 will be described with light flux controlling member 300 as an example with reference to FIG. 32.

First, as illustrated in the upper part of FIG. 32, center α of plurality of light emitting elements 220 disposed on substrate 210 is determined. Specifically, center α of four light emitting elements 220 disposed in a grid pattern is determined. Any method may be used for determine center α. For example, the intersection point of diagonal lines of a quadrangle whose corners corresponding to the centers of four light emitting elements 220 may serve as center α, or the center of gravity of the quadrangle may serve as center α.

Substrate 210 may be marked for the mounting. Such a mark may be provided anywhere, and is preferably provided, for example, at a position corresponding to center α.

Second, as illustrated in the middle part of FIG. 32, center β of light flux controlling member 300 is determined. Any method may be used for determine center β. For example, the intersection point of diagonal lines of a quadrangle whose corners corresponding to the centers of four incidence units 310 (first reflection surfaces 321) may serve as center β, or the center of gravity of the quadrangle may serve as center β.

Light flux controlling member 300 may be marked for the mounting. Such a mark may be provided anywhere, but preferably provided, for example, on a flat surface, not on reflection surfaces or an emission promotion part.

Finally, light flux controlling member 300 is mounted on a substrate in such a way that center α of plurality of light emitting elements 220 coincides with center B of light flux controlling member 300. In this manner, light flux controlling member 300 can be efficiently mounted on substrate 210 where plurality of light emitting elements 220 are disposed.

It is also possible to image-recognize the outer edge of light flux controlling member 300 in plan view for the use of alignment in the rotational direction.

This application is entitled to and claims the benefits of Japanese Patent Application No. 2020-049741 dated Mar. 19, 2020, Japanese Patent Application No. 2020-113517 dated Jun. 30, 2020, and Japanese Patent Application No. 2020-193511 dated Nov. 20, 2020, the disclosures of which each including the specification and drawings are incorporated herein by reference in their entirety.

### INDUSTRIAL APPLICABILITY

The light flux controlling member, the light emitting device, and the surface light source device of the present invention may be applied to, for example, a backlight of a liquid crystal display device or general-purpose lighting.

### REFERENCE SIGNS LIST

100 Surface light source device
100′ Display device
102 Display member
110 Casing
112 Bottom plate
114 Top plate
120 Light diffusion plate
200 Light emitting device
210 Substrate
211 Reflective sheet
220 Light emitting element
300, 400, 500, 600, 700, 800 Light flux controlling member
310, 610 Incidence unit
320, 620 Incidence surface
321, 621, 721, 821 First reflection surface
330, 630 Emission unit
332, 632 Second emission surface
333, 633 First emission surface
350 Light beam direction changing part
351 Inclined surface
352 Ridge line
361 Fourth emission surface
362 Re-incidence surface
390 Protrusion
391 First inclined surface
392 Second inclined surface
393 Ridge line of protrusion
734 Third emission surface
834 Flange
835 Outer edge
CA Central axis
LA Optical axis

1. A light flux controlling member for controlling a distribution of light emitted from a plurality of light emitting elements disposed on or above a substrate, the light flux controlling member comprising:
a plurality of incidence units for allowing incidence of the light emitted from the plurality of light emitting elements, respectively; and
an emission unit disposed between the plurality of incidence units in a direction along the substrate, the emission unit emitting the light incident on the plurality of incidence units while guiding the light,
wherein each of the plurality of incidence units includes:
an incidence surface disposed on a back side of the light flux controlling member, the incidence surface allowing incidence of the light emitted from the light emitting element, and
a first reflection surface disposed at a position opposite to each of the plurality of light-emitting elements with the incidence surface provided between the reflection surface and each of the plurality of light-emitting elements on a front side of the light flux controlling member, the reflection surface being configured to laterally reflect light entered from the incidence surface in a direction away from an optical axis of each of the plurality of light-emitting elements, and
wherein the emission unit includes:
a second emission surface disposed on the back side of the light flux controlling member, the second emission surface reflecting a part of the light from the plurality of incidence units and emitting another part of the light,
a first emission surface disposed on the front side of the light flux controlling member so as to face the second emission surface, the first emission surface reflecting a part of the light from the plurality of incidence units and emitting another part of the light, and
an emission promotion part disposed in at least one of the first emission surface and the second emission surface, the emission promotion part being for promoting emission of light traveling between the first emission surface and the second emission surface.

2. The light flux controlling member according to claim 1, wherein
the emission promotion part is a portion in which a distance between the second emission surface and the first emission surface decreases as distances from the incidence unit to the second emission surface and the first emission surface increase, the portion being in the emission unit.

3. The light flux controlling member according to claim 1 or 2, wherein
the emission promotion part is at least one member selected from the group consisting of concave surfaces, rough surfaces, fresnel surfaces, grooves, and through holes, the at least one member being disposed in at least one of the second emission surface or the first emission surface.

4. The light flux controlling member according to any one of claims 1 to 3, wherein
a shape of an outer edge of the light flux controlling member is chamfered on the front side.

5. The light flux controlling member according to any one of claims 1 to 4, wherein
light emitted from a center of the light emitting element and incident on the incidence surface reaches the first reflection surface and the first emission surface.

6. The light flux controlling member according to any one of claims 1 to 5, wherein:
each of the incidence surface and the first reflection surface is an inner surface of a recess; and
in plan view, an area of an opening edge of the recess forming the first reflection surface is 0.5 to 2.0 times an area of an opening edge of the recess forming the incident surface.

7. The light flux controlling member according to any one of claims 1 to 6, wherein
the plurality of incidence units are disposed in a grid pattern.

8. The light flux controlling member according to claim 7, wherein:
the emission unit comprises an emission unit disposed between two incidence units of the plurality of incidence units, the two incidence units being adjacent to each other in a diagonal direction of the grid; and
the emission promotion part in the emission unit disposed between the two incidence units is a concave surface.

9. The light flux controlling member according to claim 7 or 8, wherein:
the emission unit comprises an emission unit disposed between two incidence units of the plurality of incidence units, the two incidence units being adjacent to each other in a side direction of the grid; and
the emission promotion part in the emission unit disposed between the two incidence units is a concave surface or a groove.

10. The light flux controlling member according to any one of claims 1 to 9, wherein
the first reflection surface is rotationally symmetric about the optical axis of the light emitting element, and configured to approach the front side as a distance from the optical axis of the light emitting element to the first reflection surface increases.

11. The light flux controlling member according to claim 10, wherein
the first reflection surface includes a plurality of protrusions each disposed so as to connect a central part of the first reflection surface with an outer edge of the first reflection surface.

12. The light flux controlling member according to any one of claims 1 to 11, further comprising:
a third emission surface disposed at an outer peripheral part of the light flux controlling member so as to face the first reflection surface, the third emission surface emitting a part of the light reflected by the first reflection surface.

13. The light flux controlling member according to any one of claims 1 to 11, further comprising:
a flange disposed so as to protrude from a lower part of a side surface of the light flux controlling member in the direction along the substrate.

14. The light flux controlling member according to any one of claims 1 to 13, wherein:
the first reflection surface has a circular shape in plan view; and
a part of a circle whose center is identical with a center of an outer edge of the first reflection surface forms an outer edge of the light flux controlling member.

15. A light emitting device, comprising:
a plurality of light emitting elements disposed on or above a substrate; and
the light flux controlling member according to any one of claims 1 to 14, the light flux controlling member being disposed on or above the plurality of light emitting elements.

16. A surface light source device, comprising:
a plurality of the light emitting devices according to claim 15; and
a light diffusion plate that transmits light emitted from the plurality of light emitting devices while diffusing the light.

17. The surface light source device according to claim 16, wherein:
the plurality of light emitting elements are disposed in a grid pattern and separated from each other, and the plurality of light emitting devices are disposed in a grid pattern and separated from each other; and
a distance between two light emitting devices of the plurality of light emitting devices is smaller than half of a center-to-center distance of the plurality of light emitting elements, the two light emitting devices being adjacent to each other.

18. A display device, comprising:
the surface light source device according to claim 16 or 17; and
a display member to be illuminated by light emitted from the surface light source device.
